(19) United States
(12) Patent Application Publication
(10) Pub. No.: US 2025/0362166 A1
(43) Pub. Date: Nov. 27, 2025

(54) METHOD AND SYSTEM FOR DETECTING FILL IN FLUID STORAGE SYSTEMS

(71) Applicant: Rochester Sensors, LLC, Coppell, TX (US)

(72) Inventors: Connor Leinneweber, Coppell, TX (US); Dekui Qing, Coppell, TX (US); Brent Larson, Dallas, TX (US)

(21) Appl. No.: 19/172,645

(22) Filed: Apr. 7, 2025

Related U.S. Application Data
(60) Provisional application No. 63/575,622, filed on Apr. 5, 2024.

(51) Int. Cl. G01F 23/263; G01F 23/80

(52) U.S. Cl. CPC G01F 23/268; G01F 23/80

(57) ABSTRACT

A method for detecting and monitoring the fill level of a fluid in a storage tank, the method comprising: detecting an initial fluid level within the tank using a sensing circuit; periodically sampling the fluid level at a first sampling rate; detecting a change in fluid level indicative of a fill process; increasing the sampling rate to a second, higher rate in response to the detected change; displaying the updated fluid level to an operator in real-time or near real-time; determining that the fill process has ceased based on fluid level stability; and reverting the sampling rate to the first sampling rate upon cessation of the fill process.

### CROSS REFERENCE TO RELATED APPLICATIONS

The present disclosure claims priority benefit under 35 U.S.C. 119 (e) to U.S. provisional patent application Ser. No. 63/575,622 filed on Apr. 5, 2024, the subject matter thereof incorporated by reference herein in its entirety.

### FIELD OF INVENTION

This disclosure relates to fluid level measurements in a container, and more particularly, to systems and methods for detecting and monitoring fill level of a fluid in a tank being filled.

### SUMMARY

Embodiments of this disclosure comprise systems and methods that enable efficient detection, display, and monitoring of fill level of a fluid within a tank, while effectively and timely communicating those results to a user or operator by means of a low power energy source, such as a low-power battery and associated electronic components required to monitor hazardous fluids, such as propane and/or other flammable, combustible, or volatile fluids.

As is understood, an operator filling a liquid level storage system such as a propane (LPG) tank would ideally require a real-time reading of the level in the tank to enable the tank to be filled to an optimal level. Extremely hazardous material monitoring may require an electric monitor and electronic components including a low power battery without any electric sparking or in a securely enclosed electric system so as not to trigger a reaction. Optimal fill level is important for certain fluids such as propane, given that LPG expands at higher temperatures. Thus, tanks are typically filled to a lower level in hot weather relative to colder conditions. Further, some LPG tanks include a level relief valve set at a predetermined threshold (e.g. at 80% capacity) which is above the target fill threshold level for hot weather conditions.

The present disclosure improves upon various technical options for a near real-time monitoring during operator fill, by providing a system and methodology that requires neither a large battery, and hence significant energy requirements, for enabling rapid measurements, nor requires human interaction by the operator to inform the sensor to adjust sampling rates, nor complex algorithms and significant energy resources for fill detection and monitoring.

There is disclosed a system for detecting and monitoring the fill level of a fluid in a storage tank, the system comprising: a sensing circuit operable to detect fluid level within the storage tank; a microprocessor communicatively coupled to the sensing circuit, the microprocessor configured to: receive signals from the sensing circuit; compare the received signals with stored threshold values; and adjust a sampling rate of the sensing circuit based on detected fill conditions. A low-power energy source battery is configured to supply power to the system. The low-power energy source is sufficiently low-power to prevent propane from combusting within electronic circuitry, including minimizing energy storage in components, and ensuring that the minimum ignition energy (MIE) is not reached. A display is operable to present the detected fluid level to an operator in real-time.

In an embodiment, the sensing circuit comprises a capacitive sensor configured to determine fluid level based on changes in capacitance.

In an embodiment, the sensing circuit comprises a magnetic sensor configured to detect fluid level based on magnetic field variations.

In an embodiment, the microprocessor increases the sampling rate upon detecting a change in fluid level exceeding a predefined threshold.

In an embodiment, the microprocessor reduces the sampling rate after determining that the fill process has ceased.

In an embodiment, the display comprises an LCD screen configured to update in real-time or near real-time during filling operations.

In an embodiment, the system further comprises a wireless communication module configured to transmit fluid level data to a remote device.

In an embodiment, the low-power energy source comprises a battery rated for operation in a hazardous environment.

In an embodiment, the system conforms to IECEX, ATEX, UKEX, and CSA safety standards for hazardous locations.

In an embodiment, the microprocessor is configured to exit a high-sampling rate mode when the fill process has ceased for a predefined time interval.

In an embodiment, a method for detecting and monitoring the fill level of a fluid in a storage tank, the method comprises: detecting an initial fluid level within the tank using a sensing circuit; periodically sampling the fluid level at a first sampling rate; detecting a change in fluid level indicative of a fill process; increasing the sampling rate to a second, higher rate in response to the detected change; displaying the updated fluid level to an operator in real-time; determining that the fill process has ceased based on fluid level stability; and reverting the sampling rate to the first sampling rate upon cessation of the fill process.

In an embodiment, capacitive sensing is used by the sensing circuit.

In an embodiment, magnetic sensing is used by the sensing circuit.

In an embodiment, the change in fluid level is determined by comparing detected values with stored threshold values.

In an embodiment, the method further comprises transmitting fluid level data to a remote monitoring system via a wireless communication module.

In an embodiment, the method further comprises displaying a visual indication on an LCD screen corresponding to the detected fill level.

In an embodiment, the method further comprises the first sampling rate is approximately one sample per minute and the second sampling rate is approximately one sample per second.

In an embodiment, reverting the sampling rate occurs after detecting that the fluid level has remained stable for a predefined time period.

In an embodiment, the system is powered by a low-power battery rated for hazardous environments.

In an embodiment, the method further comprises executing an algorithm to determine an optimal fill level based on ambient temperature and stored tank parameters.

### BRIEF DESCRIPTION OF DRAWINGS

A more detailed understanding may be had from the following description, given by way of example in conjunction with the accompanying drawings wherein:

FIG. 1 is an exemplary illustration of a sensor module and display for connection to a mechanical float gauge or capacitive or magnetic sensing gauge for a liquid level tank according to an embodiment of the present disclosure.

FIG. 2 is an exemplary schematic illustration of components of the measurement sensor for a liquid level tank according to an embodiment of the present disclosure.

FIG. 3 is an exemplary process flow for the fill detect process of the sensor module according to an embodiment of the present disclosure.

FIG. 4 shows exemplary environmental parameters of the sensor module according to an embodiment of the present disclosure.

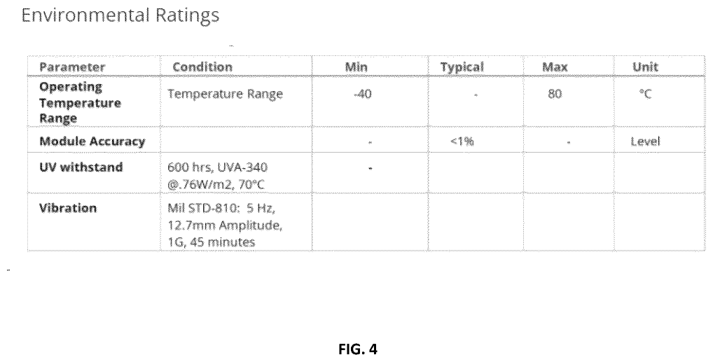

FIG. 5 shows an exemplary connection for the sensor module for connecting to a tank according to an embodiment of the present disclosure.

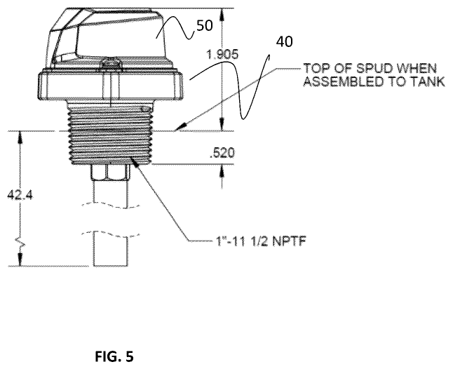

### DETAILED DESCRIPTION

In accordance with one aspect of the disclosure, a sensing circuit is communicatively coupled to a microprocessor and operable to provide a relatively slow sampling rate for ambient or non-fill detecting conditions and which switches to a faster rate when a fill is detected. Threshold values may be stored in memory for retrieval and comparison with detected values for changing modes, including sampling rate and/or precision for detection and processing within the system. The sensing circuit with automatic detection and adjustable performance and power consumption coupled to the processor such as a microcontroller and memory for executing an algorithm for adjusting the sampling rate, timing, and threshold values, enable the efficient fill detection, display, and mode conversion methodology that satisfies both the low energy requirements of the LPG hazardous fluid fill environment while providing decreased wait times for operator display and determinations during fill.

The methodology described herein can be applied to various sensor types that measure fluid level in a tank and that incorporate a local display to inform an operator filling a tank. By way of example, such technique may be implemented on capacitive sensors and/or magnetic sensors, as understood by one of ordinary skill. Capacitance sensors can be used to monitor propane levels. Compared with traditional float gauges, capacitance sensors have the advantage of no moving parts and are not subject to mechanical failures like sticking floats. Capacitance gauges use a change in height of the liquid inside the capacitor to determine a capacitance value. That capacitance value can be used with a tank model and calibration to determine the height of the liquid. By way of example, such systems may be battery powered systems having low energy requirements, where the environment is often in a hazardous location. The hazardous location requires limits on energy to avoid causing a fire/explosion in the event of a tank leaking. The combination of battery usage and hazardous location ratings provides a significant constraint on the amount of energy that can be used to sample tank level, which directly impacts how often the tank level is sampled.

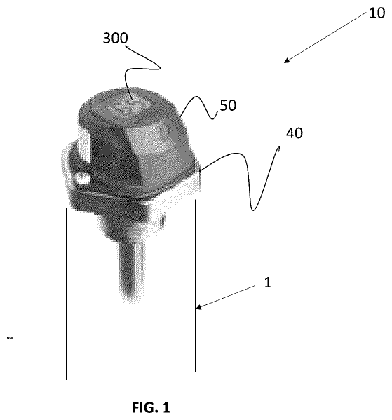

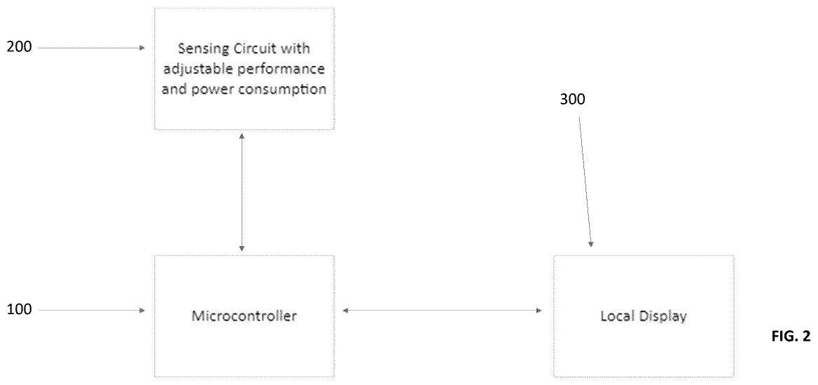

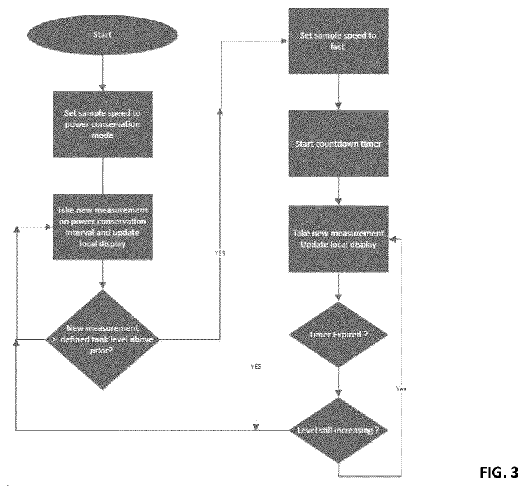

Referring now to FIG. 1 in conjunction with the components disclosed in FIG. 2 and the methodology depicted in FIG. 3 and accompanying drawings, there is shown a sensor module arrangement that is operable to sample at different time intervals and resolution. As shown, a sensor module 10 comprises housing 50 containing a sensing circuit 200 with adjustable performance and power consumption electronically coupled to a processor 100 such as a microcontroller with computation capabilities and storage (e.g. RAM) and a local display 300 to inform an operator of near real-time liquid level within a tank 1. The housing 50 containing display 300 is battery operated and fully sealed and mounted on the top of the tank. The battery is a low-powered battery configured to supply power to the system. The low-power energy source is sufficiently low-power to prevent propane from combusting within electronic circuitry, including minimizing energy storage in components, and ensuring that the minimum ignition energy (MIE) is not reached. The display is operable to present the detected fluid level to an operator in real-time or near real-time.

By way of example, a typical measurement for a liquid level tank may be a reading of X samples/minute for normal operation (e.g. 1 sample/minute). During normal operation, the level in the tank is relatively static and therefore is not expected to change dramatically over a short time interval (e.g. approximately 60 seconds). For a capacitive sensor, a higher precision measurement can be obtained by employing a longer sampling time. However, such increased precision comes at the cost of increased energy consumption.

According to an aspect of the present disclosure, samples taken at a slightly increased, yet intermediate, sampling rate (e.g. 1 sample per approximately 20 seconds vs. 1 sample/minute) using a medium precision measurement may be implemented. A processor 100 (e.g. microcontroller with memory) receives the measurement result from the sensing circuit 200 and compares to the prior measurement value. If the new value is greater than the previous value by a given threshold (e.g. noise threshold), processor 10 determines that the tank is being filled and changes mode to cause the sampling rate to increase (e.g. shorten the sampling time between measurements to 1 sample/see, for example). This allows the local display 300 to be updated at a faster rate, thereby enabling the operator to timely receive updates as to the filling rate and filling progress associated with filling the tank. When the processor detects that the tank is sufficiently close to a predetermined full value condition (by means of comparison with another threshold value, such as 80% of capacity) and that the filling process has stopped due to lack of increase in level, the processor is configured to revert back to the lower system power sampling interval (i.e. typically 1 sample/20 seconds, as per above), in order to optimize energy consumption.

By way of example, specific limits are a function of the sensor and the battery selected. In a magnetic sensing system, the ability to shorten/lengthen a measurement may not exist so the variable is the time interval between samples. A similar process can be used to detect a fill and change the update rate to a shorter interval during the fill time.

FIG. 3 shows a process flow associated with the fill detect measurement and mode detection and transition process, according to an aspect of the present disclosure. Typical fill level thresholds would be a predetermined value (e.g. 3% or higher) to avoid any noise in a reading or any mechanical disturbance, e.g. vibration. The level must be higher than the prior value which can only occur during filling in a storage tank as consumption from the tank would lower the level from the prior reading.

The amount of time to stay on during a fill could be set by either a fixed amount of time for a given weight tank (e.g. 5 minutes for a 420 lb propane tank), or by an algorithm which analyzes the rate of change of the input signal. By way of example only, detection of a modification of a rate of change of the input signal by a given amount indicative that the signal has stopped increasing, then the algorithm operates to predict that the fill is over and turn off the fill detect mode.

The methodology described herein can be applied to various sensor types that measure fluid level in a tank and that incorporate a local display to inform an operator filling a tank. By way of example, such technique may be implemented on capacitive sensors and magnetic sensors, as understood by one of ordinary skill.

By way of example, such systems may be battery powered systems having low energy requirements, and the environment is often in a hazardous location. The hazardous location requires limits on energy to avoid causing a fire/explosion in the event of a tank leaking. The combination of battery plus hazardous location ratings provides a significant constraint on the amount of energy that can be used to sample tank level, which directly impacts how often the tank level is sampled.

On a practical basis, liquid propane tanks can be filled at approximately 1 gallon per second. For a 120 gallon tank with an 80% typical fill value, filling a tank from the 30% point to the 80% point could require less than 1 minute. The local display is to be in a near real-time mode within about 20 seconds (<25 seconds) of initiating a fill to allow the operator time to react to stop the fill when the tank is getting close to the target 80% point.

Thus, there is disclosed a technique to detect a liquid level tank being filled. The sensor updates the local display at a faster rate during a fill to allow the operator to know when the tank is near the optimum fill level. In between fills, the sensor operates at a lower power level to save energy.

Further, there is disclosed a capacitance level sensor that measures liquid level in a propane tank without relying on a mechanical system. The capacitive technology removes any moving parts inside the tank eliminating interference between the sensor, tank wall, and other components. The replaceable electronics module is battery powered and provides a periodic BLE broadcast output and a visual digital readout. These options not only allow users to read the tank level in person but enable telemetry units to connect and monitor the level as well. The device conforms to typical IECEX/ATEX/UKEX/CSA safety requirements for use in Class 1 Division 1 (Zone 0) hazardous locations. The electronics module is designed to support a 10-year battery life and can be replaced at the end of its service interval. The probe inside the tank is permanently mounted and left in place when the electronics module is replaced. The electronics module is not user serviceable.

A local LCD shows the current tank level in percentage on a large, easy-to-read display. The LCD is always on and is automatically updated anytime the sensor reads a new level. Sensor status information is displayed on the LCD as well as level to assist the user in maintaining the propane level.

Wireless operation simplifies installation and eliminates common issues with cable connection and cable damage. A broadcast occurs every 2.2 seconds so telemetry units can scan at any time and obtain the latest level and sensor status. The broadcast status will indicate additional information such as errors and low or high warnings. Estimated battery life is included in the broadcast and can be used to create an estimated battery percentage. The system also supports OTA (Over the air) firmware updates via a Bluetooth interface.

### Application

By way of non-limiting example, the system may be embodied as a capacitance propane level sensing unit with no moving parts. In an embodiment, a new level reading is acquired every 15 seconds and updates the LCD and BLE broadcast on the fly. As described herein, the system incorporates a fill detect mode. When a fill is detected, the sensor will acquire new level readings every second and update the LCD. The system will automatically exit fill detect mode upon expiration of a timer and/or detection of a given rate of change of fill (i.e. no more fill).

The capacitive sensing element is permanently installed into the tank and the calibration data for the unit is stored inside it. Replacing the electronics is simple and can be performed when the battery is consumed without the user needing to perform any set up or calibration to use the system.

Wide Temperature Range:−40° C. to +80° C.
a. Probe Assembly-No moving parts
b. high accuracy at low tank levels
c. Mechanically robust, designed for transporting and setting tanks and cylinders.
d. Sensor mounting options include 4-bolt and various NPTF adapter sizes.
e. probe seal designed to prevent content leakage under extreme conditions.

### Features

Polycarbonate housing offers strong mechanical properties, UV, and chemical resistance.

No exposed sensing elements, all components are located on the PCB inside the housing.

Housing: IK9 impact rating

Ingress Protection: IP69K9 rated.

### Benefits

BLE broadcast for simple and robust communications
Fast installation time
Easy to read digital display shows tank volume in 1% increments.
Rugged plastic housing
1″ NPTF threaded connection to tank standard.

### Broadcast Protocol

PACKET TYPE 0x0101 TELEMETRIC
PACKET 2.2 sec INTERVAL

| Bytes | Payload Contents | Description |
|---|---|---|
| 0 | Flag 0 | BLE Protocol Specified |
| 1 | Flag 1 | BLE Protocol Specified |
| 2 | Flag 2 | BLE Protocol Specified |
| 3 | Length | 0x14 |
| 4 | Type Flag (0xFF) | Manufacturer Specific |
| | | Data |
| 5 | MM - Byte 03 | 0x7F - RS ID from |
| | | bluetooth.com |
| 6 | MM - Byte 13 | 0x0C - RS ID from |
| | | bluetooth.com |
| 7 | Byte 1 RS device name | 0x52 - ASCII “R” |
| 8 | Byte 2 RS device name | 0x4F - ASCII “O” |
| 9 | Byte 3 RS device name | 0x53 - ASCII “S” |
| 10 | Byte 4 RS device name | 0x63 |
| 11 | Byte 5 RS device name | 0x20 |
| 12 | 0x01 (identification of | LSB |
| | content type) | |
| 13 | 0x01 (identification of | MSB |
| | content type) | |
| 14 | Status1 | See status table |
| 15 | RAW DATA TYPE | 0x00 = % |
| 16 | RAW DATA LSB2 | |
| 17 | RAW DATA MSB2 | |
| 18 | Reserved | |
| 19 | Battery LSB | (uint16) Battery Raw = |
| | | (uint16)(Battery |
| | | MSB\|BatteryLSB) |
| 20 | Battery MSB | Battery Raw/(0xFFFF) = |
| | | (uiint16)(% Battery |
| | | Remaining) |
| 21 | Reserved | |
| 22 | Reserved | |
| 23 | Version | 0x0A-0x0F |

Thus, there is disclosed a system and method for level sensor measurement of a liquid level in a propane tank without relying on a mechanical system. Implementation of a capacitive sensor embodiment removes any moving parts inside the tank eliminating interference between the sensor, tank wall, and other components. A replaceable electronics module is battery powered and provides a periodic BLE broadcast output and a visual digital readout. These options not only allow users to read the tank level in person but enable telemetry units to connect and monitor the level as well. The device is also operative to conform to typical IECEX/ATEX/UKEX/CSA safety requirements for use in Class 1 Division 1 (Zone 0) hazardous locations.

It will be appreciated by those skilled in the art that changes can be made to the embodiments described above without departing from the broad inventive concept thereof. It will be understood, therefore, that this invention is not limited to the particular embodiments disclosed, but is intended to cover modifications within the spirit and scope of the present invention.

What is claimed is:

1. A system for detecting and monitoring the fill level of a fluid in a storage tank, the system comprising:
a sensing circuit operable to detect fluid level within the storage tank;
a microprocessor communicatively coupled to the sensing circuit, the microprocessor configured to:
receive signals from the sensing circuit;
compare the received signals with stored threshold values;
adjust a sampling rate of the sensing circuit based on detected fill conditions;
a low-power energy source configured to supply power to the system; and
a display operable to present the detected fluid level to an operator in real-time or near real-time.

2. The system of claim 1, wherein the sensing circuit comprises a capacitive sensor configured to determine fluid level based on changes in capacitance.

3. The system of claim 1, wherein the sensing circuit comprises a magnetic sensor configured to detect fluid level based on magnetic field variations.

4. The system of claim 1, wherein the microprocessor increases the sampling rate upon detecting a change in fluid level exceeding a predefined threshold.

5. The system of claim 1, wherein the microprocessor reduces the sampling rate after determining that the fill process has ceased.

6. The system of claim 1, wherein the display comprises an LCD screen configured to update in real-time during filling operations.

7. The system of claim 1, further comprising a wireless communication module configured to transmit fluid level data to a remote device.

8. The system of claim 1, wherein the low-power energy source comprises a battery rated for operation in a hazardous environment.

9. The system of claim 1, wherein the system conforms to IECEX, ATEX, UKEX, and/or CSA safety standards for hazardous locations.

10. The system of claim 1, wherein the microprocessor is configured to exit a high-sampling rate mode when the fill process has ceased for a predefined time interval.

11. A method for detecting and monitoring the fill level of a fluid in a storage tank, the method comprising:
detecting an initial fluid level within the tank using a sensing circuit;
periodically sampling the fluid level at a first sampling rate;
detecting a change in fluid level indicative of a fill process;
increasing the sampling rate to a second, higher rate in response to the detected change;
displaying the updated fluid level to an operator in real-time or near real-time;
determining that the fill process has ceased based on fluid level stability; and
reverting the sampling rate to the first sampling rate upon cessation of the fill process.

12. The method of claim 11, wherein the sensing circuit comprises a capacitive sensor.

13. The method of claim 11, wherein the sensing circuit comprises a magnetic sensor.

14. The method of claim 11, wherein the change in fluid level is determined by comparing detected values with stored threshold values.

15. The method of claim 11, further comprising transmitting fluid level data to a remote monitoring system via a wireless communication module.

16. The method of claim 11, further comprising displaying a visual indication on an LCD screen corresponding to the detected fill level.

17. The method of claim 11, wherein the first sampling rate is approximately one sample per minute and the second sampling rate is approximately one sample per second.

18. The method of claim 11, wherein reverting the sampling rate occurs after detecting that the fluid level has remained stable for a predefined time period.

19. The method of claim 11, wherein the system is powered by a low-power battery rated for hazardous environments.

20. The method of claim 11, further comprising executing an algorithm to determine an optimal fill level based on ambient temperature and stored tank parameters.
